(19) United States
(12) Patent Application Publication
(10) Pub. No.: US 2013/0042968 A1
(43) Pub. Date: Feb. 21, 2013

(54) Method for Auxiliary-Assembling Micro-Components through Liquid Medium

(71) Applicants: Ker-Win Wang, Changhua City (TW); Huo-Chuan Lin, Puxin Township (TW); Pei-Yu Huang, Zhunan Township (TW); Chia-Chung Wang, New Taipei City (TW)

(72) Inventors: Ker-Win Wang, Changhua City (TW); Huo-Chuan Lin, Puxin Township (TW); Pei-Yu Huang, Zhunan Township (TW); Chia-Chung Wang, New Taipei City (TW)

(73) Assignee: NATIONAL CHANGHUA UNIVERSITY OF EDUCATION, Changhua City (TW)

(21) Appl. No.: 13/524,296

(22) Filed: Jun. 15, 2012

(30) Foreign Application Priority Data
Aug. 19, 2011 (TW) 100129683

(51) Int. Cl. B32B 37/12; B23K 31/02

(52) U.S. Cl. 156/230; 228/246

(57) ABSTRACT

A method for auxiliary assembling micro-components though liquid medium. This method includes following steps: providing a substrate, an adhesive layer, at least one micro-component and a liquid medium, wherein the adhesive layer is on the substrate and the micro-component and the liquid medium are on the adhesive layer. The adhesive is used for adhering one side of the micro-component and another side of the micro-components is disposed with is disposed with the liquid medium. Then, the another side of the micro-component which is disposed with the liquid medium touches a target area, and the substrate moves toward the target zone at a speed that is smaller than 90 μm/s for placing the micro-component on the target zone or moves away from the target zone at a speed greater than 4370 μm/s for picking up the micro-component from the target zone.

### CROSS-REFERENCE TO RELATED APPLICATION

This application claims the benefit of Taiwan Patent Application No. 100129683, filed on Aug. 19, 2011, in the Taiwan Intellectual Property Office, the disclosure of which is incorporated herein in its entirety by reference.

### BACKGROUND OF THE INVENTION

1. Field of the Invention

The present invention relates to a method for assembling micro-components, in particular to the method for auxiliary-assembling micro-components through liquid medium.

2. Description of the Related Art

In a civilization evolution, people do not only use hands to assemble components but also assemble components that are not directly assembled by hands. The foregoing situation has two situations: one situation is too big and unable to be assembled by hands; another situation is too small and unable to be assembled by hands or even automatic pick and place robotic tweezers.

In the situation that smallest component is unable to be assembled, such as the size with micrometers or nanometers, the specific property of the substances are always utilized to achieve the assembly effect. For example, a region of a substrate may have difference between hydrophilicity and hydrophobicity after special treatment. Next, when a substrate covered with thin oil films is immersed into water, the oil drop will remain on the hydrophobic region. The micro-component, which has been treated with hydrophobic surface treatment, will stay on the oil drop due to the minimization of interfacial surface energy.

However, the foregoing manner merely performs simple assembled structure while requiring beforehand surface treatment. It may not achieve while synchronously assembling complex multi-dimensional 3D structures in mass.

### SUMMARY OF THE INVENTION

In view of the shortcomings of the prior art, the inventor(s) of the present invention based on years of experience in the related field to conduct extensive researches and experiments, and developed a method for auxiliary-assembling micro-components through liquid medium as a principle objective to overcome a problem that is unable to synchronously assemble multi-dimensional microstructures in mass.

Thus, to achieve the foregoing objective, a method for auxiliary-assembling micro-components through liquid medium according to the invention includes the following steps: firstly providing a substrate, an adhesive layer, at least one micro-component and a liquid medium. The adhesive layer is located on the substrate, and the micro-component and the liquid medium are located on the adhesive layer. The adhesive layer is used for adhering one side of the micro-component and another side of the micro-component is disposed with the liquid medium. Wherein, the adhesive layer can be made of polydimethylsiloxane (PDMS), and the micro-component can, but not limited to, be spherical shape.

Further, the substrate having the adhesive layer can be firstly produced while providing the foregoing components. The micro-component is firstly placed on another substrate having a trap structure. Next, the substrate is moved to move the adhesive layer to a relative position of another substrate placed with the micro-component. The micro-component is adhered to the adhesive layer. Afterward, the substrate is moved to allow the micro-component to wet the liquid medium. The substrate is distant from the liquid medium by moving at a speed that is smaller than a specific speed after the micro-component is wet with the liquid medium, such that the micro-component can be remained to the adhesive layer. The specific speed relates to specific gravity, viscosity, surface tension, contact angles and imposed contact areas of selected liquid medium. Taking a metallic ball (solder ball) having 300 micrometers in diameter as an example, the specific speed can be smaller than 90 micrometers/seconds so that the micro-component can be placed on the target region. However, when the specific speed is greater than 4370 micrometers/second, the metallic ball (solder ball) is taken away from the target region. It is noteworthy to point out the liquid medium can be the oil drop, ultraviolet curing glue, infrared curing glue, thermal cure glue or conductive glue. The selected liquid medium relates to the demand of subsequent assembly steps. In another word, the oil drop and conductive particles or conductive glue can be used to achieve the assembly through tin soldering, heat curing or photo-curing if the design of assembling the micro-component has conductive demand. If the design of assembling the micro-component does not have conductive demand, the liquid drop can be used as the liquid medium by selecting insulation ultraviolet or infrared optical glue, thereby using photo-curing for assembly. In addition, the foregoing step can be reversely performed. In other words, the adhesive zone is firstly wet with the liquid medium, and then the substrate is moved to allow the adhesive layer to adhere to the micro-component.

The subsequent step is that another side of the micro-component which is disposed of the liquid medium is in contact with the target region. The target region can include another micro-component. Then, the substrate is selectively distant from the target region at a speed that is greater or smaller than the specific speed so that the micro-component is placed on the target region or taken away from the target region. The invention mainly utilizes features of the surface tension of the liquid medium and the weight of the micro-component and allows the micro-component to freely select whether or not it is placed on the target region via effect relationship of different speeds. In another word, if the situation that the micro-component is placed on the target region is not good enough, the micro-component can be distant from the target region by means of a motion that is smaller than the specific speed, so as to achieve re-assembly. If the situation that the micro-component is placed on the target region is good enough, the micro-component can be retained at the target region by means of a motion that is greater than the specific speed.

The method for auxiliary-assembling micro-components through liquid medium according to the invention has the following advantages:

1. The method for auxiliary-assembling micro-components through liquid medium utilizes features of the surface tension of the liquid medium and the weight of the micro-component and allows the micro-component to freely select whether or not it is placed on the target region via effect relationship of different speeds.

2. With the feature of the liquid medium, the assembly of the micro-component can be a complex three-dimensional assembly structure.

### BRIEF DESCRIPTION OF THE DRAWINGS

FIG. 1 is a flowchart of a method for auxiliary-assembling micro-components through liquid medium according to the invention;

FIG. 2 is a first schematic diagram of a method for auxiliary-assembling micro-components through liquid medium according to a first embodiment of the invention;

FIG. 3 is a second schematic diagram of a method for auxiliary-assembling micro-components through liquid medium according to a first embodiment of the invention;

FIG. 4 is a third schematic diagram of a method for auxiliary-assembling micro-components through liquid medium according to a first embodiment of the invention;

FIG. 5 is a fourth schematic diagram of a method for auxiliary-assembling micro-components through liquid medium according to a first embodiment of the invention;

FIG. 6 is a fifth schematic diagram of a method for auxiliary-assembling micro-components through liquid medium according to a first embodiment of the invention;

FIG. 7 is a sixth schematic diagram of a method for auxiliary-assembling micro-components through liquid medium according to a first embodiment of the invention;

FIG. 8 is a seventh schematic diagram of a method for auxiliary-assembling micro-components through liquid medium according to a first embodiment of the invention;

FIG. 9 is a first schematic diagram of a method for auxiliary-assembling micro-components through liquid medium according to a second embodiment of the invention;

FIG. 10 is a second schematic diagram of a method for auxiliary-assembling micro-components through liquid medium according to a second embodiment of the invention;

FIG. 11 is a third schematic diagram of a method for auxiliary-assembling micro-components through liquid medium according to a second embodiment of the invention;

FIG. 12 is a fourth schematic diagram of a method for auxiliary-assembling micro-components through liquid medium according to a second embodiment of the invention;

FIG. 13 is a fifth schematic diagram of a method for auxiliary-assembling micro-components through liquid medium according to a second embodiment of the invention;

FIG. 14 is a sixth schematic diagram of a method for auxiliary-assembling micro-components through liquid medium according to a second embodiment of the invention; and

FIG. 15 is a schematic diagram of a micro-component assembled by a method for auxiliary-assembling micro-components through liquid medium.

### DETAILED DESCRIPTION OF THE PREFERRED EMBODIMENTS

The technical characteristics of a method for auxiliary-assembling micro-components through liquid medium of the present invention may become apparent with the detailed description of the preferred embodiments and the illustration of the related drawings. It is noteworthy to point out that same numerals are used in the following preferred embodiments to represent respective elements.

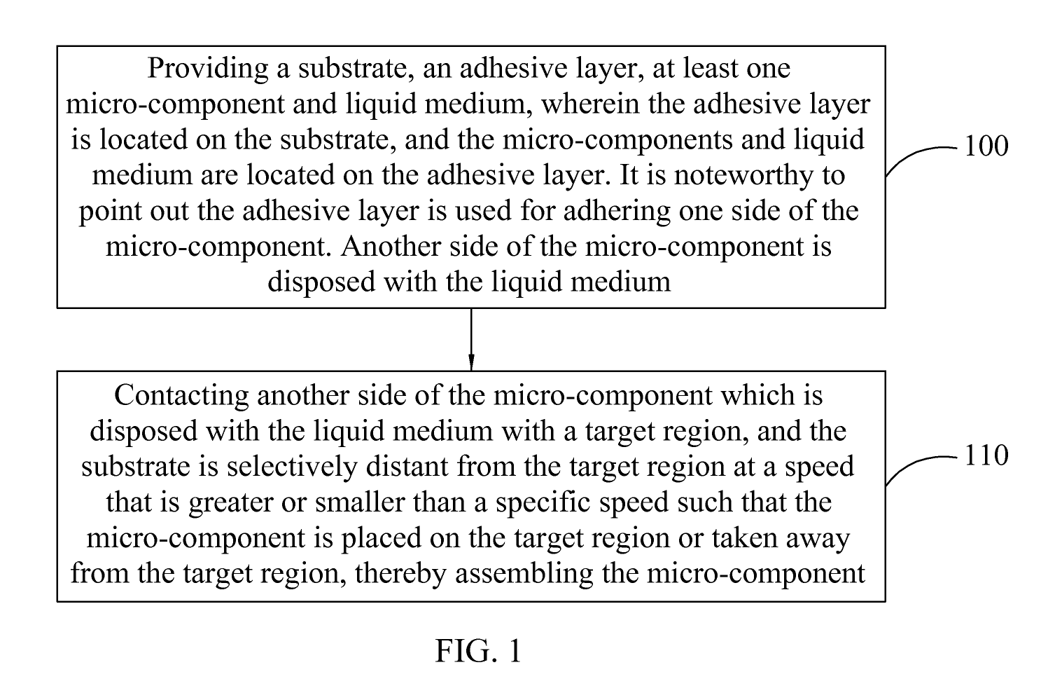

With reference to FIG. 1 for a flowchart of a method for auxiliary-assembling micro-components through liquid medium according to the invention is depicted. As shown in FIG. 1, the method for auxiliary-assembling micro-components through liquid medium according to the invention includes the following steps: firstly, the step 100 provides a substrate, an adhesive layer, at least one micro-component and liquid medium, wherein the adhesive layer is located on the substrate, the micro-component and liquid medium are located on the adhesive layer. It is noteworthy to point out the adhesive layer is used for adhering one side of the micro-component. Another side of the micro-component has liquid medium. The adhesive layer can be made of polydimethulsiloxane (PDMS). The liquid medium can be selected from the oil drop, heat curing glue or ultraviolet curing glue. It should be noted herein that the selected liquid medium relates to the demand of subsequent assembly steps. In another word, if the design of assembling the micro-component has conductive demand, liquid drop and conductive particles or conductive glue can be used to achieve the assembly through tin soldering or photo-curing. If the design of assembling the micro-component does not have conductive demand, the liquid drop can be used as the liquid medium by selecting insulation ultraviolet or optical glue.

In the embodiment, the step 110 expressed contacting a target region by another side of the micro-component having the liquid medium, and the substrate is selectively distant from the target region at a speed that is greater or smaller than a specific speed such that the micro-component is placed on or taken away from the target region, so as to assembling the micro-component. Wherein, the target region can include another micro-component. In other words, the micro-components are mutually assembled. The specific speed relates to specific gravity, viscosity, surface tension, contact angles and imposed contact areas of selected liquid medium. Taking a metallic ball (solder ball) having 300 micrometers in diameter as an example, the specific speed can be smaller than 90 micrometers/seconds, so that the micro-component can be placed on the target area. However, when the specific speed is greater than 4370 micrometer/second, the metallic ball (solder ball) is taken away from the target region. The invention mainly utilizes features of the surface tension of liquid medium and the weight of the micro-component and allows the micro-component to freely select whether or not it is placed on the target region via effect relationship of different speeds. In another word, if the situation that the micro-component is placed on the target region is not good enough, the micro-component can be distant from the target region by means of a motion that is smaller than the specific speed, so as to achieve re-assembly. If the situation that the micro-component is placed on the target region is good enough, the micro-component can be retained at the target region by means of a motion that is greater than the specific speed. (The specific speed is determined by the viscosity, density, surface energy, dipping geometry of the droplet and the inertial force of the micro-component.)

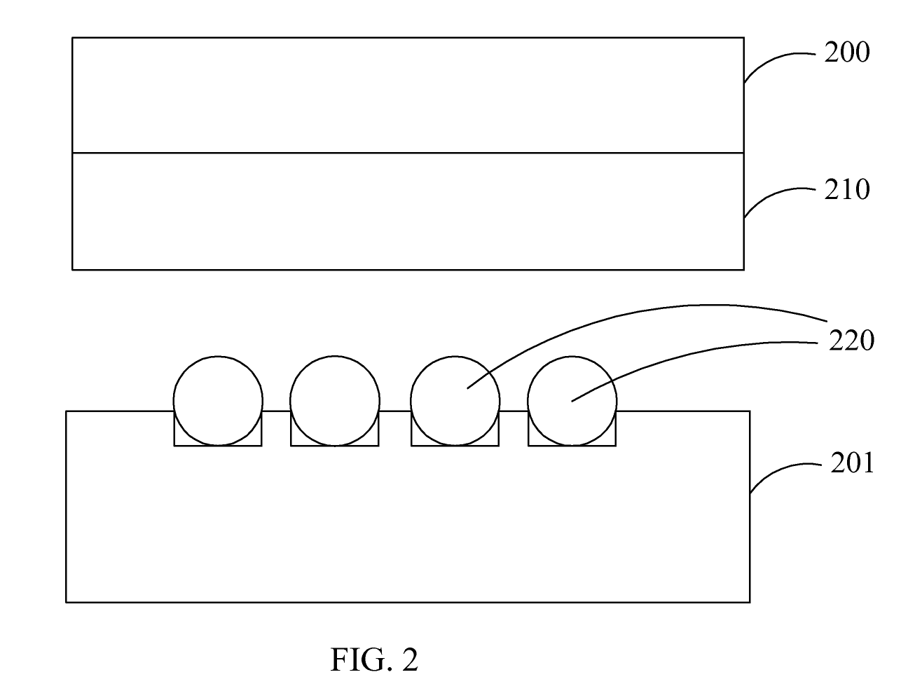

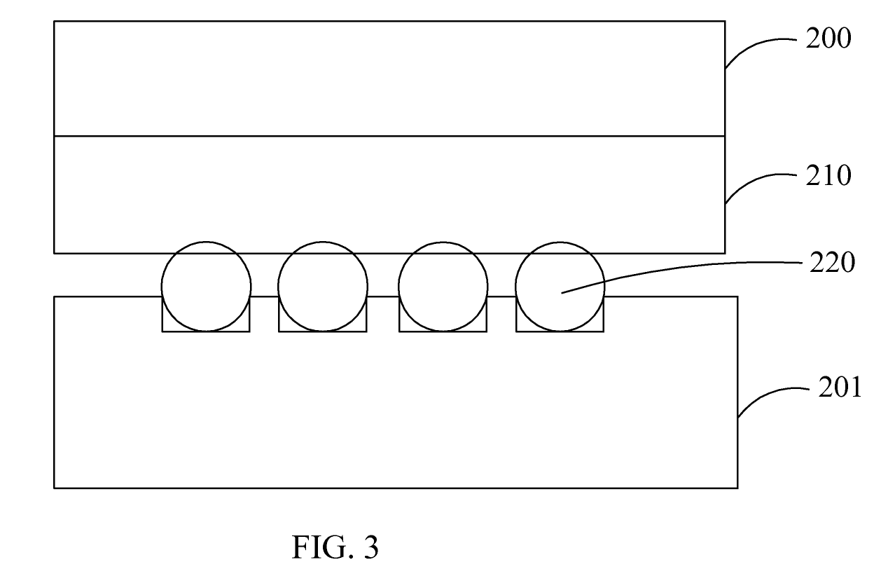

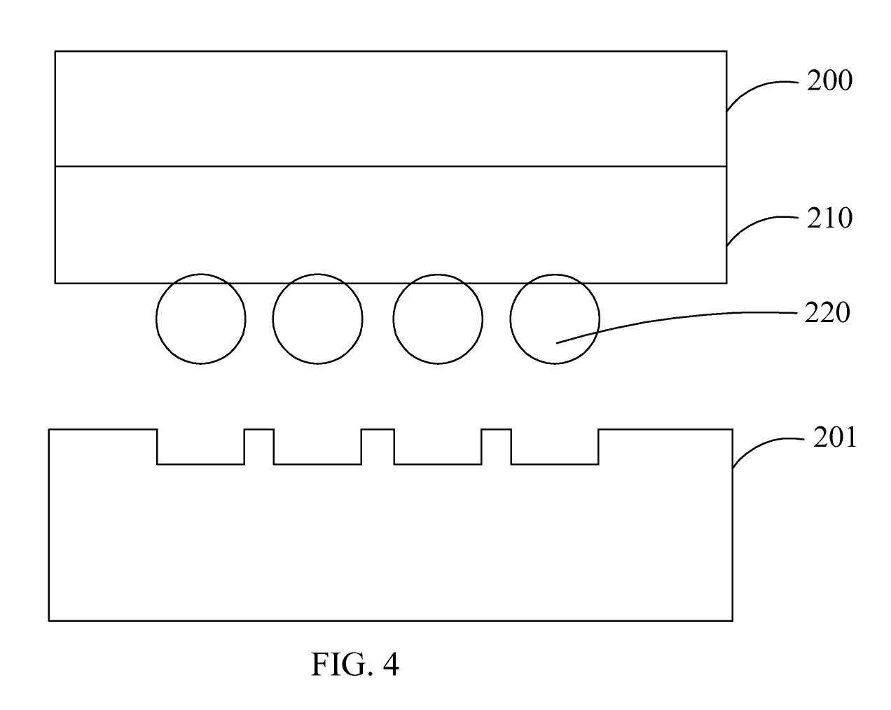

To further understand the advantage of the method for auxiliary-assembling micro-components through liquid medium according to the invention, an embodiment is provided by the inventor. With reference to FIG. 2 to FIG. 4, FIG. 2 is a first schematic diagram of a method for auxiliary-assembling micro-components through liquid medium according to a first embodiment of the invention; FIG. 3 is a second schematic diagram of a method for auxiliary-assembling micro-components through liquid medium according to a first embodiment of the invention; and FIG. 4 is a third schematic diagram of a method for auxiliary-assembling micro-components through liquid medium according to a first embodiment of the invention. In FIG. 2 to FIG. 4, a substrate 200 having an adhesive layer 210 is firstly provided, and taking the micro-components 220 which is spherical in shape as an example, the micro-components 220 is placed on another substrate 201 having a trap. The shape of the trap can be at least one cavity or a plurality of cavities in the presence of a matrix. The effect of the trap can arrange the micro-components 220 produced in mass, so as to facilitate the assembly favorably, and the adhesive layer 210 is adhered to the micro-components 220 and distant from another substrate 201.

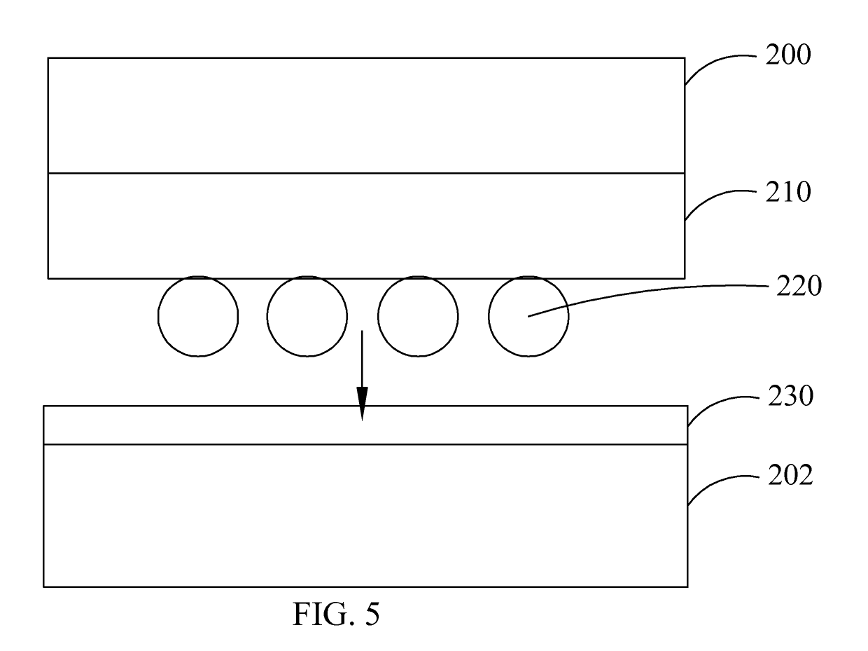

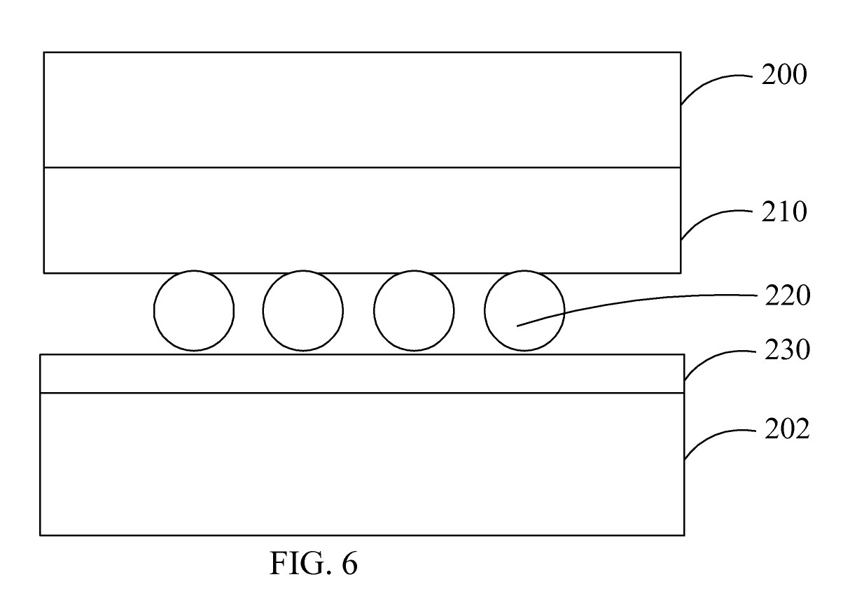

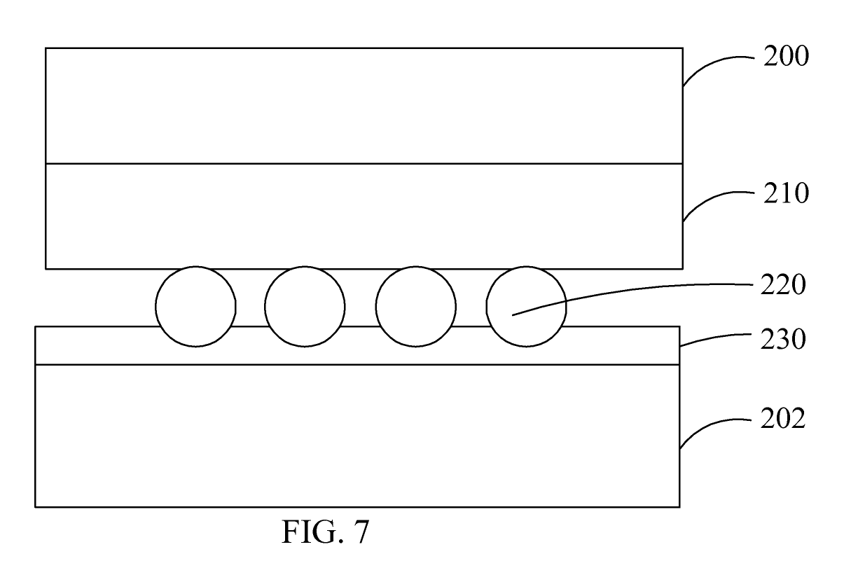

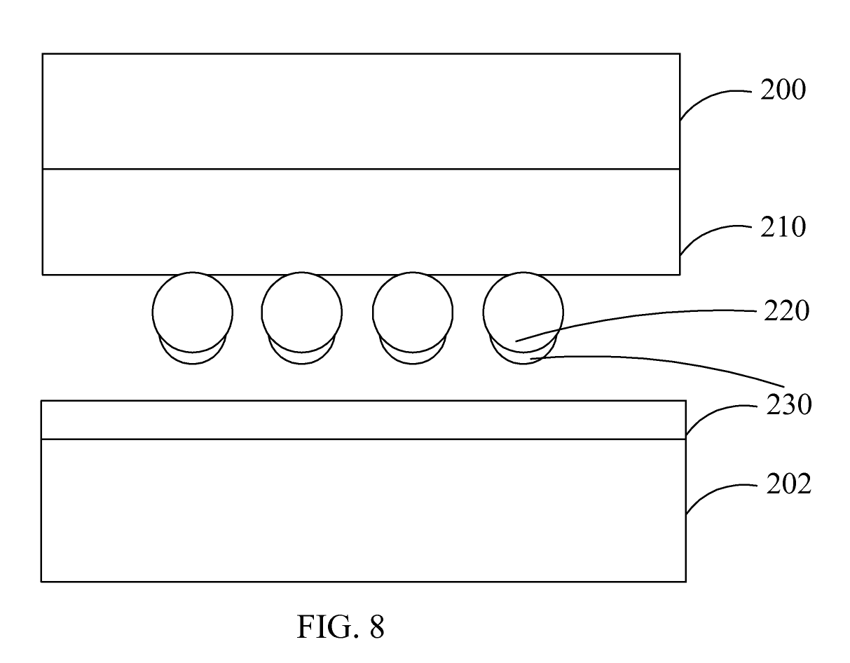

With reference to FIG. 5 to FIG. 8, FIG. 5 is a fourth schematic diagram of a method for auxiliary-assembling micro-components through liquid medium according to a first embodiment of the invention, FIG. 6 is a fifth schematic diagram of a method for auxiliary-assembling micro-components through liquid medium according to a first embodiment of the invention, FIG. 7 is a sixth schematic diagram of a method for auxiliary-assembling micro-components through liquid medium according to a first embodiment of the invention and FIG. 8 is a seventh schematic diagram of a method for auxiliary-assembling micro-components through liquid medium according to a first embodiment of the invention. In FIG. 5 to FIG. 8, the substrate 200 is moved above the substrate 202 having the liquid medium 230. The micro-components 220 is wet with the liquid medium 230, and the substrate 200 is distant from the substrate 202 and the liquid medium 230 in a speed that is smaller than 90 micrometer/second. Wherein, the micro-components 220 are wet with the liquid medium 230. It should be noted herein the liquid medium 230 is used for auxiliary-assembling the micro-components 220.

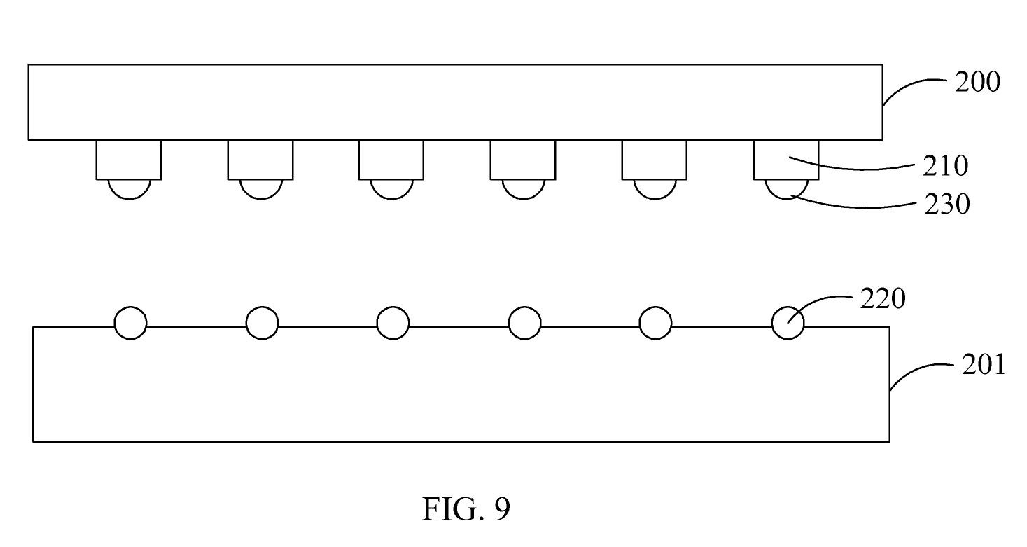

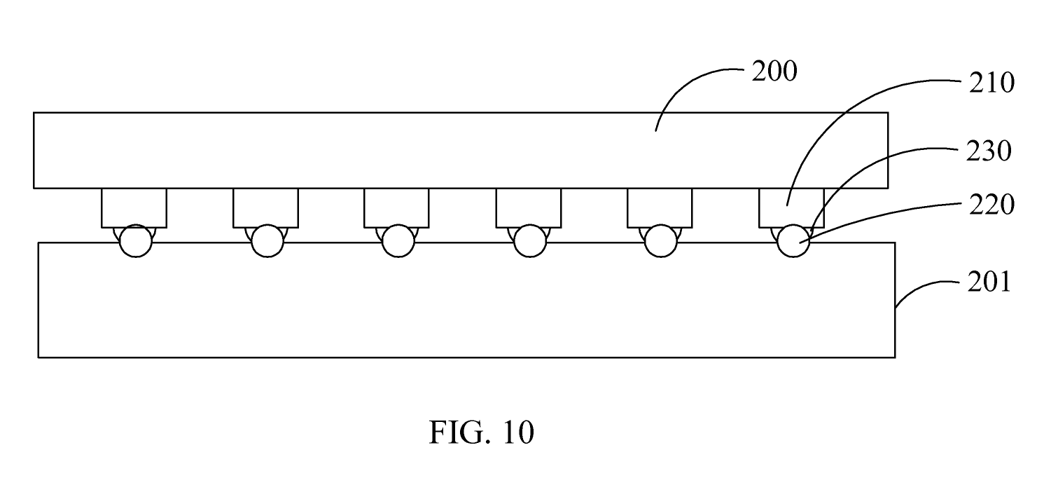

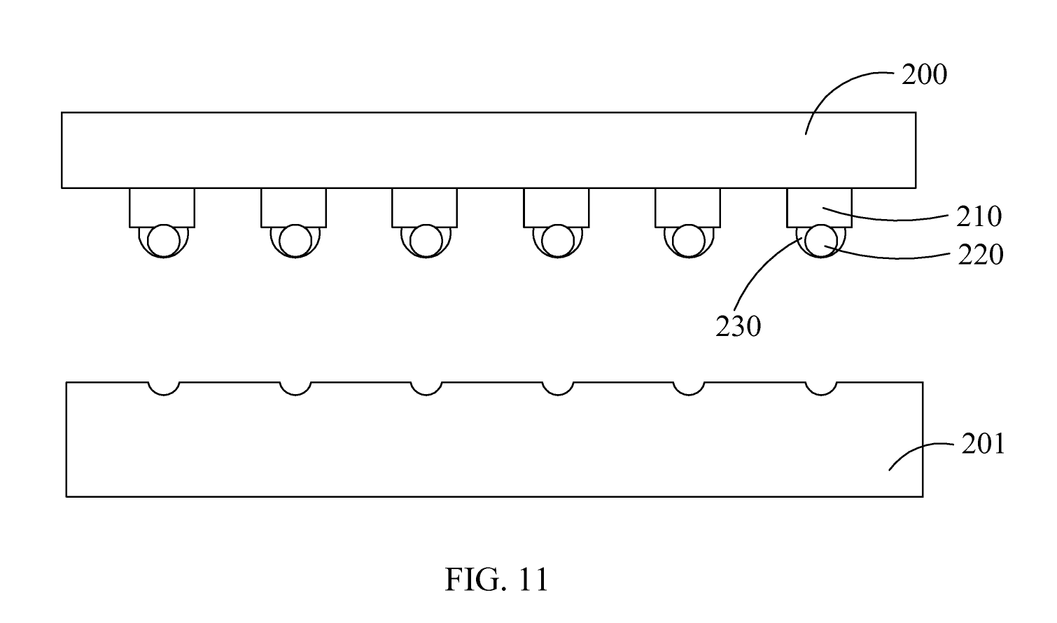

In addition, the foregoing steps can be reversely performed. With reference to FIG. 9 to FIG. 11, FIG. 9 is a first schematic diagram of a method for auxiliary-assembling micro-components through liquid medium according to a second embodiment of the invention, FIG. 10 is a second schematic diagram of a method for auxiliary-assembling micro-components through liquid medium according to a second embodiment of the invention and FIG. 11 is a third schematic diagram of a method for auxiliary-assembling micro-components through liquid medium according to a second embodiment of the invention. In FIG. 9 to FIG. 11, the adhesive layer 210 is firstly wet with the liquid medium 230 on the substrate 200, and the micro-components 220 is adhered to the adhesive layer 210 located on another substrate 201. In another word, the step of providing the liquid medium 230 or the micro-components 220 can be exchanged.

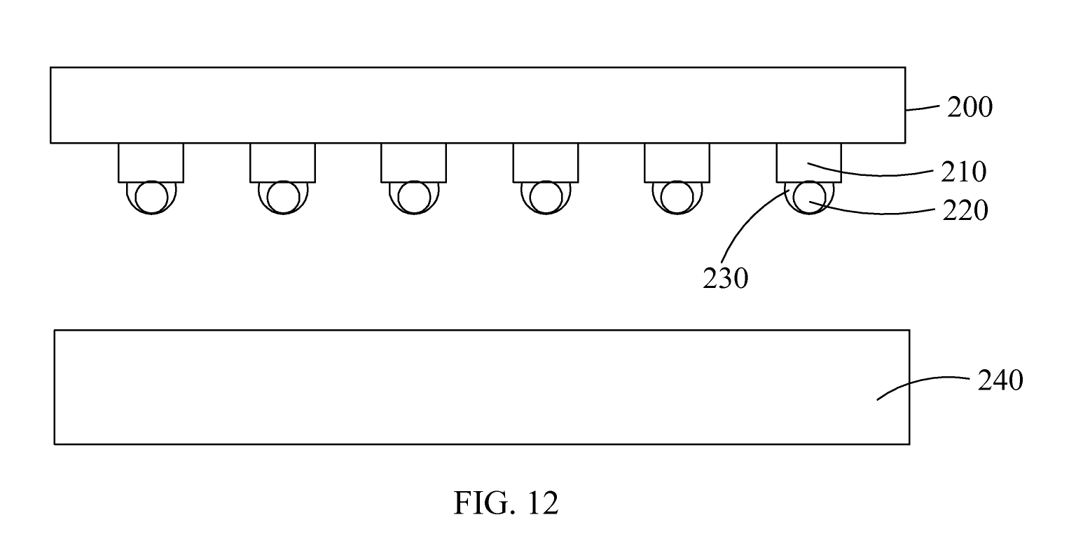

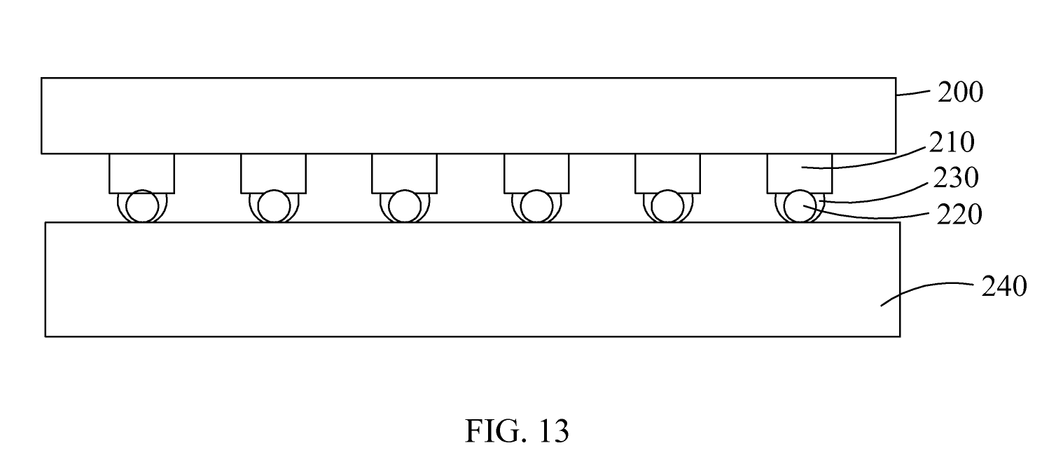

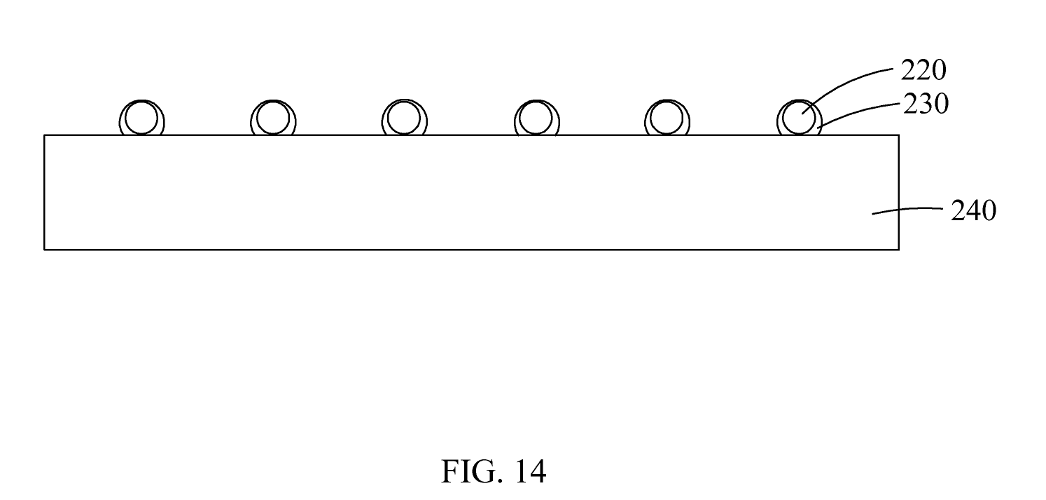

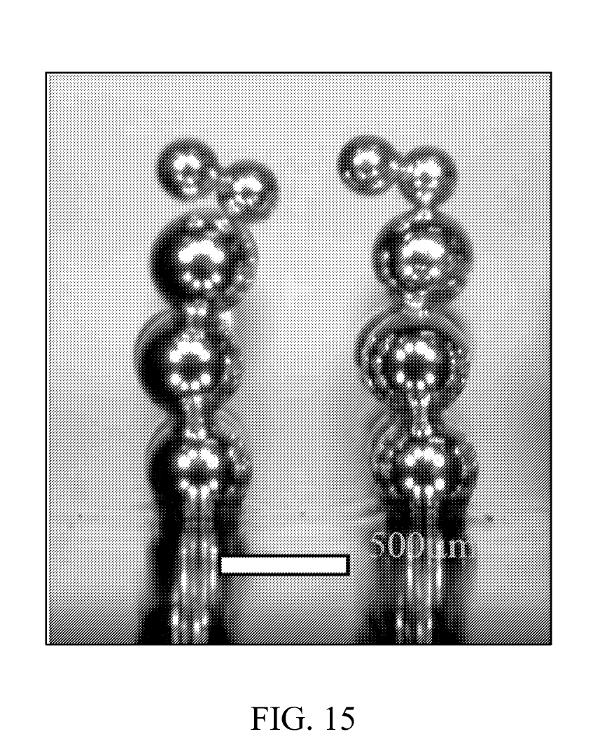

With reference to FIG. 12 to FIG. 14, FIG. 12 is a fourth schematic diagram of a method for auxiliary-assembling micro-components through liquid medium according to a second embodiment of the invention, FIG. 13 is a fifth schematic diagram of a method for auxiliary-assembling micro-components through liquid medium according to a second embodiment of the invention and FIG. 14 is a sixth schematic diagram of a method for auxiliary-assembling micro-components through liquid medium according to a second embodiment of the invention. As shown in FIG. 12 to FIG. 14, the substrate 200, the adhesive layer 210 the micro-components 220 and the liquid medium 230 is transferred to the target region 240, and another side of the micro-components 220 having the liquid medium 230 is in contact with the target region 240. In the embodiment, the micro-components 220 are placed on the target region 240 because of the speed that is distant from the target region 240 is larger than 90 micrometer/second. With reference to FIG. 15, FIG. 15 is a schematic diagram of a micro-component assembled by a method for auxiliary-assembling micro-components through liquid medium. In FIG. 15, the micro-components 220 assembled by the method for auxiliary-assembling micro-components through liquid medium can show three-dimensional direction state. Further, another micro-component 221 can be assembled to any orientation of the micro-components 220 and may not fail in assembly due to the influence of the weight of the micro-components 220.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A method for auxiliary-assembling micro-components through liquid medium comprising:
providing a substrate, an adhesive layer, at least one micro-component and a liquid medium, wherein the adhesive layer is located on the substrate, and the micro-component and the liquid medium are located on the adhesive layer, and the adhesive layer is used for adhering one side of the micro-component and an another side of the micro-component is disposed with the liquid medium; and
contacting the another side of the micro-component having the liquid medium with a target region and allowing the substrate to be selectively distant from the target region at a speed that is greater or smaller than a specific speed so that the micro-component is placed on the target region or taken away from the target region to assemble the micro-component.

2. The method for auxiliary-assembling micro-components through liquid medium as recited in claim 1, wherein the micro-component is made of tin.

3. The method for auxiliary-assembling micro-components through liquid medium as recited in claim 2, wherein in the step of assembling the micro-component, the micro-component is assembled through tin soldering.

4. The method for auxiliary-assembling micro-components through liquid medium as recited in claim 1, wherein the liquid medium is an oil drop, ultraviolet curing glue, heat curing glue, infrared curing glue or conductive glue.

5. The method for auxiliary-assembling micro-components through liquid medium as recited in claim 4, wherein in the step of assembling the micro-component, the micro-component is assembled by photo-curing manner.

6. The method for auxiliary-assembling micro-components through liquid medium as recited in claim 1, wherein the target region further includes another micro-component, and the micro-component is assembled to the another micro-component.

7. The method for auxiliary-assembling micro-components through liquid medium as recited in claim 1, wherein the micro-component is a metallic ball with 300 micrometers in diameter, and the metallic ball is placed on the target region when the specific speed is smaller than 90 micrometers/second, and the metallic ball is taken away from the target region when the specific speed is greater than 4370 micrometers/second.

8. The method for auxiliary-assembling micro-components through liquid medium as recited in claim 7, wherein the metallic balls are solder balls.

9. The method for auxiliary-assembling micro-components through liquid medium as recited in claim 1, wherein in the step of providing the substrate, the adhesive layer, the micro-component and the liquid medium, the micro-component is adhered to the liquid medium, and the substrate is distant from the liquid medium at a speed that is smaller than the specific speed to remain the micro-component on the adhesive layer.

10. The method for auxiliary-assembling micro-components through liquid medium as recited in claim 1, wherein the adhesive layer is made of polydimethylsiloxane (PDMS).

11. The method for auxiliary-assembling micro-components through liquid medium as recited in claim 1, wherein the micro-component is spherical in shape.
